(19) United States
(12) Patent Application Publication
(10) Pub. No.: US 2025/0177934 A1
(43) Pub. Date: Jun. 5, 2025

(54) Reconfigurable Platform and Platform Rocker

(71) Applicant: Forward Biotech, Inc., Troy, NY (US)

(72) Inventors: Ian K. Glasgow, Averill Park, NY (US); David Lala, Clifton Park, NY (US); Daniel Carlo, Johnsonville, NY (US)

(21) Appl. No.: 18/962,195

(22) Filed: Nov. 27, 2024

Related U.S. Application Data
(60) Provisional application No. 63/605,232, filed on Dec. 1, 2023.
(60) Provisional application No. 63/605,455, filed on Dec. 1, 2023.

(51) Int. Cl. B01F 31/20; B01F 31/23; B01F 31/80

(52) U.S. Cl. CPC B01F 31/201; B01F 31/23; B01F 31/89

(57) ABSTRACT

A tiltable platform, a tiltable platform device having a base and a tiltable platform mounted to the base, as well as a method of configuring the tiltable platform. A control unit is configured to move the tiltable platform in a specified pattern as part of a process. The tiltable platform can include a structure at least partially defining multiple mounting locations located thereon. Each mounting location can define a position for placing a cartridge in a predetermined orientation with respect to movement of the tiltable platform. The structure can be configured for selective placement in any one of multiple positions, which can form mounting locations having differing sizes and/or differing orientations with respect to the base. The tiltable platform can include more than one tier of mounting locations, and each tier of mounting locations can have any of various orientations with respect to the adjacent tiers of mounting locations.

### REFERENCE TO RELATED APPLICATIONS

The current application claims the benefit of U.S. Provisional Application No. 63/605,232, filed on 1 Dec. 2023, and U.S. Provisional Application No. 63/605,455, filed on 1 Dec. 2023, each of which is hereby incorporated by reference. Aspects of the disclosure are related to concurrently filed U.S. patent application Ser. No. 18/961,724, filed on 27 Nov. 2024, which is hereby incorporated by reference.

### TECHNICAL FIELD

The disclosure relates generally to platform rockers, and more particularly, to a platform rocker capable of having multiple levels for cartridge placement.

### BACKGROUND ART

Platform rockers are mainly used for keeping fluids flowing or mixing, such as for incubation and washing steps with blots and DNA hybridization.

Many laboratories culture cells in microfluidic channels, such as for tissue growth. Often, there is a desire to flow culture medium past the cells during culturing. To date, approaches to flow culture medium use pumps or passively with reservoirs and gravity. When using gravity, it is usually desired to reverse the direction of flow periodically, to reuse the medium.

Some platform rockers can perform a continuous punctuated cycle, which can include moving to a tilt angle, dwelling at the tilt angle for a period of time, moving to a reverse tilt angle, and dwelling at the reverse tilt angle for a period of time. The punctuated cycle can be repeated. However, to date, such rockers are limited in function and are derived from existing rocker technology.

### SUMMARY OF THE INVENTION

The inventors propose a platform rocker that provides one or more new and useful features and benefits. Embodiments of the platform rocker can enable better control of the flow of the medium, include an easier to use control interface, provide an ability to run more complex cycles, have a more flexible manufacturing procedure, and/or the like.

Embodiments include a device with a tiltable platform that can be accurately controlled and easily programmed. Such a configuration can enable users to better control the flow of culture medium for perfusion systems, such as cell culture and in vitro fertilization systems, etc. Embodiments of a system including a device with a tiltable platform can enable scientists to research the effects of one or more parameters, such as flow rate, and thus optimize the parameter(s) for the best results. Embodiments of a device including the tiltable platform also can be used for other applications that require tilting including, for example, gravity controlled fluidic systems, systems in which objects are controlled by tilting to travel through channels, etc.

Aspects of the invention provide a tiltable platform, a tiltable platform device having a base and a tiltable platform mounted to the base, as well as a method of configuring the tiltable platform. A control unit is configured to move the tiltable platform in a specified pattern as part of a process. The tiltable platform can include a structure at least partially defining multiple mounting locations located thereon. Each mounting location can define a position for placing a cartridge in a predetermined orientation with respect to movement of the tiltable platform. The structure can be configured for selective placement in any one of multiple positions, which can form mounting locations having differing sizes and/or differing orientations with respect to the base. The tiltable platform can include more than one tier of mounting locations, and each tier of mounting locations can have any of various orientations with respect to the adjacent tiers of mounting locations.

Aspects of the invention provide a device with a reconfigurable tiltable platform that can support culture cartridges and other systems in which the tilt angle can be easily and accurately controlled. In embodiments, the tiltable platform can be configured to securely hold culture cartridges in any of multiple desired orientations, while enabling the culture cartridges to be readily loaded and removed by a user. In embodiments, the tiltable platform can be selectively reconfigured by a user, e.g., without tools, while secured to a corresponding platform rocker device.

In embodiments, a rack for holding multiple tiers (levels, layers) of cartridges is affixed to the tiltable platform or directly to the platform rocker device, such as via rocker arms. A rack can be configured to enable air flow between cartridges. This is advantageous over simply stacking cartridges directly on top of each other, which severely limits air flow to all but the top cartridge. Spacing the culture cartridges, rather than stacking them on top of each other, can allow for significantly more air exchange to the cartridges. Furthermore, embodiments of a stacking solution described herein can provide for ease of loading and unloading any desired cartridge without disturbing the other cartridges.

In an illustrative embodiment, a rocking device including a platform configured to support one or more cartridges and a computing unit configured to control a tilt angle of the platform is described. The rocking device can include a motor, a platform, a base, and a user control component. In embodiments, the movement of the platform is driven by a motor with accurate shaft rotation control, such as a stepper motor or a motor with an encoder. In embodiments, the motor can drive a transmission for mechanical advantage and increased tilt angle accuracy of the attached platform. One or more sensors can monitor the tilt angle of the platform, to enable the control system to accurately control the tilt angle.

A first aspect provides a device comprising: a base; a tiltable platform mounted to the base, wherein the tiltable platform includes a structure defining at least one side of each of a plurality of mounting locations located on the tiltable platform, each mounting location defining a position for placing a cartridge in a predetermined orientation with respect to movement of the tiltable platform, wherein the structure is configured for selective placement by a user in any one of a plurality of positions while the tiltable platform is mounted to the base, wherein the plurality of positions form mounting locations having differing sizes and/or differing orientations with respect to the base; and a control unit configured to move the tiltable platform in a specified pattern as part of a process.

A second aspect provides a reconfigurable platform configured for mounting on a tiltable platform device, the platform comprising: a platform configured to be secured to the tiltable platform device; a first plurality of mounting locations located on a first tier on the platform, each mounting location configured to securely hold a cartridge in a first predetermined orientation with respect to movement of the platform by the tiltable platform device; and a plurality of stacking features configured to define a second tier including a second plurality of mounting locations on the platform having a second predetermined orientation with respect to the movement of the platform, wherein the first predetermined orientation and the second predetermined orientation are selected from a plurality of user selectable predetermined orientations with respect to the movement of the platform.

A third aspect provides a multi-tier platform configured for mounting on a tiltable platform device, the platform comprising: a plurality of tiers, each tier including a plurality of mounting locations, each mounting location configured to securely hold a cartridge in a predetermined orientation with respect to movement of the platform, wherein the predetermined orientation is selected from a plurality of user selectable predetermined orientations with respect to the movement of the platform; and a plurality of elevation structures defining a predetermined spacing between the plurality of tiers.

The illustrative aspects of the invention are designed to solve one or more of the problems herein described and/or one or more other problems not discussed.

### BRIEF DESCRIPTION OF THE DRAWINGS

These and other features of the disclosure will be more readily understood from the following detailed description of the various aspects of the invention taken in conjunction with the accompanying drawings that depict various aspects of the invention.

FIG. 1 shows an illustrative platform rocker device according to an embodiment.

FIG. 2 shows components of an illustrative platform rocker device according to an embodiment.

FIGS. 3A and 3B show an illustrative platform mounted to a base, shown with and without a housing, respectively, according to embodiments.

FIGS. 4A and 4B show further details of an illustrative platform and an illustrative dock bar, respectively, according to embodiments.

FIGS. 5A and 5B show perspective and exploded perspective views of an illustrative multi-tier platform according to embodiments.

FIG. 6 shows an illustrative culture plate rack according to embodiments.

FIGS. 7A and 7B show perspective and exploded perspective views, respectively, of an illustrative cartridge rack according to embodiments.

FIGS. 8A and 8B show an illustrative cartridge rack mounted to the base of a platform rocker device in two different orientations according to embodiments.

FIGS. 9A-9C show more detailed views of illustrative components of an illustrative cartridge rack according to embodiments.

FIGS. 10A and 10B show an illustrative cartridge rack, without and with cartridges, respectively, having an interdigitated arrangement according to embodiments.

It is noted that the drawings may not be to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As used herein, a “lateral orientation,” “laterally tilted,” and similar terms are used to describe configurations in which the shorter sides of a corresponding feature are located in the front/back of the feature, such as when a platform rocker device is viewed from the front. Additionally, as used herein, a “longitudinal orientation,” “longitudinally tilted,” and similar terms are used to describe configurations in which the longer sides of a corresponding feature are located in the front/back of the feature, such as when a platform rocker device is viewed from the front.

A tiltable platform device having a base and a tiltable platform mounted to the base as well as a method of configuring the tiltable platform are described. A control unit is configured to move the tiltable platform in a specified pattern as part of a process. The tiltable platform can include multiple mounting locations located thereon. Each mounting location can define a position for placing a cartridge in a predetermined orientation with respect to movement of the tiltable platform. The tiltable platform can include more than one level of mounting locations, and each level of mounting locations can have any of various orientations with respect to the adjacent levels of mounting locations.

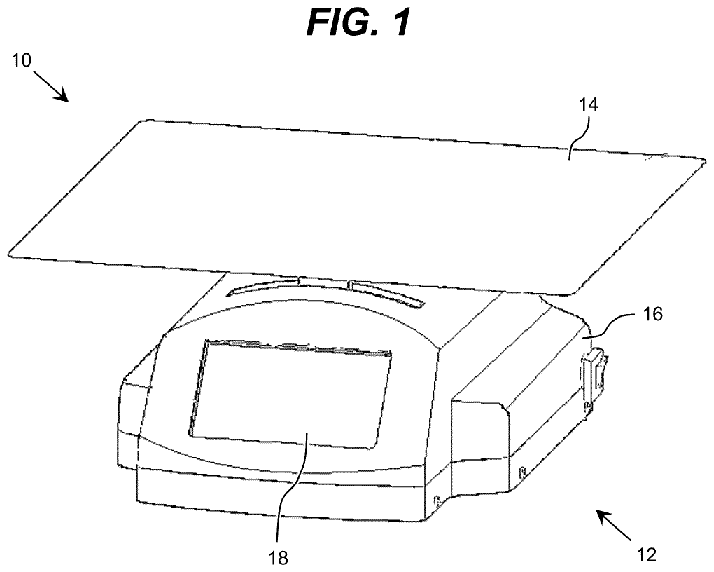

Turning to the drawings, FIG. 1 shows an illustrative platform rocker device 10 according to an embodiment. The platform rocker device 10 can include a base 12, which supports a platform 14. The base 12 can comprise various components that enable the platform 14 to be moved in a controlled manner. For example, the base 12 can be configured to move the platform 14 in a side-to-side rocking motion. Such a rocking motion can cause the platform 14 to tilt to one side or the other.

The base 12 is shown including a housing 16 which can cover and protect various components located therein. The components can include a user interface 18, such as a touchscreen, which can enable a user to input and/or view a desired motion, motion parameters, status, etc.

While the user interface 18 is illustrated as enabling a human user to interface with the platform rocker device 10, it is understood that embodiments of the user interface 18 can be configured for interfacing with another computing device or computer system. In either case, the user interface can enable a user (human or another computer) to direct operation of the platform rocker device 10.

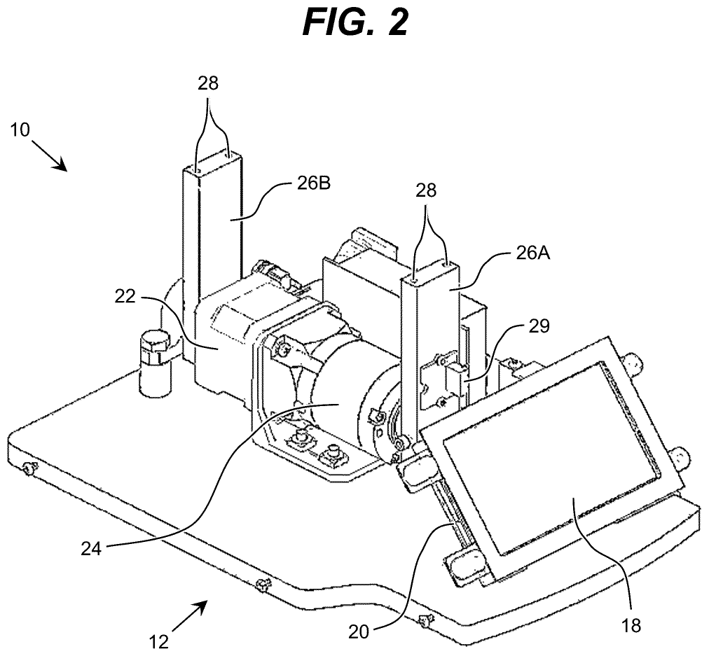

FIG. 2 shows internal components of a base 12 of an illustrative platform rocker device 10 according to an embodiment. For example, the internal components can correspond to internal components of the platform rocker device 10 shown in FIG. 1.

The components can include a control component 20, which can be implemented as a circuit board or the like, and which is shown located behind the user interface 18. The control component 20 can send and receive data via the user interface 18 and operate a motor 22 according to operating information received by the user interface 18 and/or program instructions stored on the control component 20.

It is understood that a circuit board is only illustrative of any of various computing units which can be used to implement the control component 20 of the platform rocker device 10 described herein. In embodiments, some or all of the processing for moving the platform 14 (FIG. 1) as described herein can be performed on a computer system located external to the platform rocker device 10. In this case, the computer system can communicate with the control component 20 using any solution in order to direct operation of the motor 22 to accomplish the desired motion. To this extent, such communication can use any combination of optical fiber, wired, and/or wireless links; utilize any combination of one or more types of networks; and/or utilize any combination of various types of transmission techniques and protocols. In an embodiment, a software application executing on an external computing device, such as a handheld computing device, can enable the handheld computing device to control operation of the platform rocker device 10 and/or receive information regarding the operation of the platform rocker device 10. For example, such information can include a progress of an experiment, one or more measurements acquired during the experiment, an alert due to a malfunction, etc.

The control component 20 can be configured to move the platform 14 in a side-to-side rocking motion, thereby adjusting a tilt angle of the platform 14 in an automated, semi-automated, and/or manual process. In embodiments, the motor 22 can comprise a variable speed motor 22, which can include a shaft and/or a corresponding flange that can be rotated in either direction, clockwise or counter clockwise. In embodiments, the motor 22 can comprise accurate shaft rotation control. For example, the motor 22 can comprise a stepper motor, a motor with an encoder which drives a transmission, and/or the like.

The platform rocker device 10 is shown including to arms 26A, 26B on which the platform 14 can be mounted. The motor 22 is shown connected to a gear box 24 which can drive motion of a front arm 26A. The motion can include side-to-side motion described herein. In embodiments, motion of a rear arm 26B follows that of the front arm 26A. However, it is understood that this configuration is only illustrative of various possible configurations for driving the motion of the arms 26A, 26B.

The platform 14 can be attached to the front arm 26A and the rear arm 26B using any permanent or removable solution. In embodiments, the platform 14 can be attached to the arms 26A, 26B using bolts which can be inserted by turning into complementary threaded mounting holes 28. However, it is understood that this solution is only illustrative of various solutions for attaching the platform 14 to the arms 26A, 26B.

Regardless, in embodiments, the control component 20 can operate the motor 22 to adjust the tilt angle of the platform 14 according to a predefined process or user defined process. To this extent, a user can instruct the control component 20 to follow a desired process in order to adjust the tilt angle of the platform 14 in a desired manner. In embodiments, the control component 20 can be pre-configured with a selectable set of programmed processes. In embodiments, a user can provide a new programmed process or modify an existing programmed process for execution by the control component 20 using the user interface 18.

In embodiments, the platform rocker device 10 can include one or more sensing devices, each of which can be configured to provide data for processing by the control component 20 and use during execution of a process. For example, a sensing device 29, such as an accelerometer, is shown attached to the front arm 26A. The sensing device 29 can be configured to acquire data corresponding to an angle of the front arm 24A, which can be provided for processing by the control component 20. The control component 20 can use data received from the sensing device 29 to determine one or more attributes of the platform 14. For example, the control component 20 can process the data corresponding to the angle of the arm 26A to calculate an angle of the platform 14.

It is understood that the sensing device 29 is only illustrative of various possible types and/or configurations of sensing devices that can be implemented in the platform rocker device 10. To this extent, a sensing device described herein can be configured to sense one or more attributes of a corresponding arm 26A, 26B, the platform 14, the base 12, etc. Information received by the control component 20 from the sensing device(s) 29 can be used to accurately perform the specified process.

Additionally, one or more sensing devices can be configured to provide other types of sensing data. For example, the platform rocker device 10 can include one or more sensing devices configured to acquire information regarding an ambient environment, such as temperature, humidity, light intensity, etc. Additionally, the platform rocker device 10 can include one or more sensing devices configured to acquire information on the platform 14, such as a current angle, a current rate of change of the angle, and/or the like. The platform rocker device 10 also can include one or more sensing devices to acquire information on the base 12, such as one or more angles of a spatial orientation of the base 12. Still further, the control component 20 can be configured to acquire information regarding one or more experiments being conducted on the platform 14. To this extent, the platform rocker device 10 can include an imaging device (e.g., infrared, near infrared, visible, and/or the like), which can acquire image data for an experiment located on the platform 14.

Similarly, components placed on the platform 14 for the experiment can be configured to interface with the control component 20 to provide any of various types of information on the experiment, such as a direction/rate of flow of a culture medium, a color of a culture, a temperature, etc. In embodiments, the platform 14 can comprise an at least partially contained environment for an experiment located thereon. In this case, the platform 14 and/or one or more components of the experiment located within the at least partially contained environment can comprise one or more components (e.g., output devices, sensors, etc.), which operate independently and/or which the control component 20 can operate to affect the environment, obtain data regarding the environment, and/or the like. In embodiments, the platform rocker device 10 can be placed in and operate in a larger controlled environment, such as a carbon dioxide cell culture incubator.

Additional details regarding platform rocker devices 10 capable of performing additional motions are shown and described in the above-referenced concurrently filed patent application.

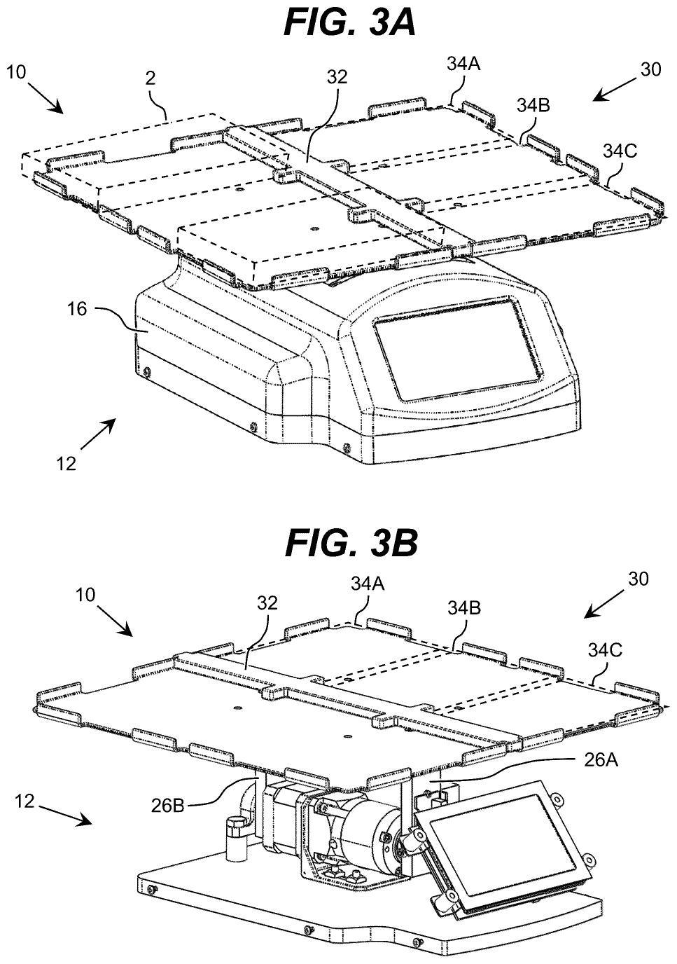

Embodiments of a platform rocker device 10 described herein can include a platform 14 configured to securely and concurrently hold multiple cartridges. To this extent, FIGS. 3A and 3B show an illustrative platform 30 mounted to a base 12, shown with and without a housing 16, according to embodiments. As illustrated, the base 12 can include arms 26A, 26B on which the platform 30 can be mounted, e.g., similar to the platform 14 shown in FIG. 1. For example, the platform 30 can be mounted using screws, which are subsequently covered by a dock bar 32 described herein.

As illustrated, the platform 30 and dock bar 32 can be configured to create secure mounting locations, such as mounting locations 34A-34C, to concurrently hold up to six cartridges 2 arranged on the platform 30. In the configuration shown, each mounting location 34A-34C is longitudinally oriented, with the long sides of located in the front/back. However, it is understood that the number and arrangement of mounting locations 34A-34C and corresponding cartridges 2 that can be mounted on the platform 30 are only illustrative.

Additionally, the platform 30 and dock bar 32 are shown mounted to the base 12 such that each mounting location 34A-34C for a cartridge 2 is longitudinally oriented with its long sides located in the front/back. In this case, the long side of each cartridge 2 can be aligned with the side to side direction of the rocking of the platform 30. However, it is understood that this arrangement also is only illustrative. For example, in embodiments, the platform 30 and dock bar 32 can be mounted to the base 12 such that each mounting location 34A-34C for a cartridge 2 is laterally oriented with its long sides located in the front/back. In this case, the short side of each cartridge 2 can be aligned with the side to side direction of the rocking of the platform 30.

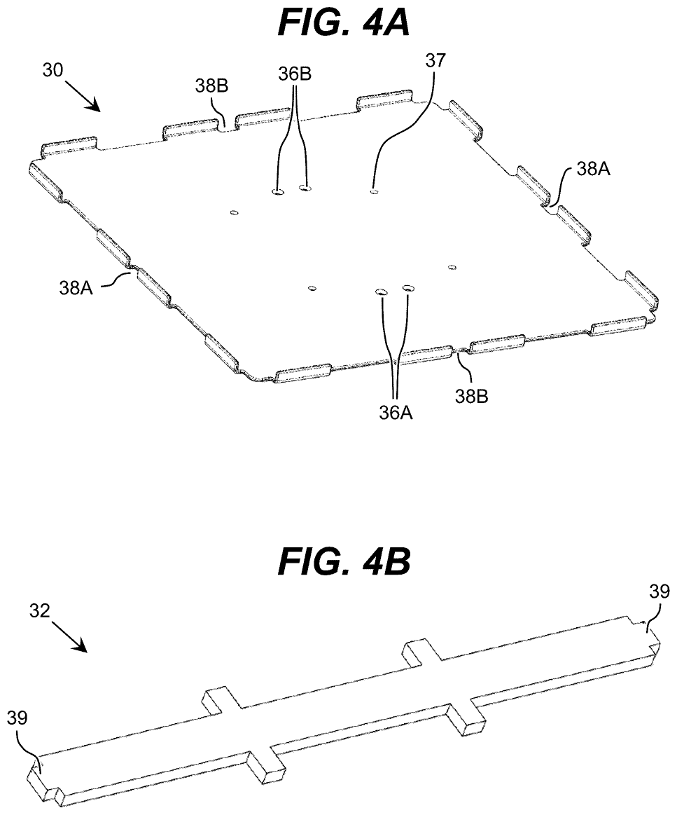

FIGS. 4A and 4B show further details of an illustrative platform 30 and an illustrative dock bar 32, respectively, according to embodiments. As illustrated, embodiments of the platform 30 can have an approximately square shape. The platform 30 is shown including two sets of mounting holes 36A, 36B. A first set of mounting holes, such as the mounting holes 36A, can be configured to align with and be used to mount the platform 30 to the mounting holes 28 of the front arm 26A shown in FIG. 2. Similarly, a second set of mounting holes, such as the mounting holes 34B, can be configured to align with and be used to mount the platform 30 to the mounting holes 28 of the rear arm 26B shown in FIG. 2. As described herein, the platform 30 can be secured to the arms 26A, 26B using screws or the like. To this extent, the holes 36A, 36B can be countersunk to accommodate flat head screws or the like, to mount the platform 30 to the arms 26A, 26B. Use of flat head screws or something similar with countersunk holes 36A, 36B enables the mounting structure to not protrude above the surface of the platform 30.

In embodiments, the dock bar 32 is configured to be positioned or repositioned to the platform 30 in one of a plurality of locations or removed by a user without any tools. In embodiments, the positioning, repositioning, and removal of the dock bar 32 can be performed while the platform 30 is secured to the base 12. Embodiments of the plate dock platform 30 can include a pair of lateral dock bar slots 38A and a pair of longitudinal dock bar slots 38B. As illustrated in FIG. 4B, the dock bar 32 can include dock bar tabs 39 which are configured to selectively fit in either the pair of lateral dock bar slots 38A or the pair of longitudinal dock bar slots 38B to secure the dock bar 32 in place with a transition fit (e.g., also referred to as a push fit or a snug fit). To this extent, the dock bar 32 can be oriented laterally or longitudinally. In embodiments, a lateral or longitudinal location of the dock bar 32 can be selectively modified. In this case, the platform 30 can include multiple pairs of lateral dock bar slots 38A and/or longitudinal dock bar slots 38B, which correspond to predetermined locations for the dock bar 32. In other embodiments, the dock bar 32 can be secured to the plate dock platform 30 using an alternative solution, which enables placement of the dock bar 32 in any lateral or longitudinal location along the platform 32.

When installed, the dock bar 32 can be configured to position cartridges 2 (e.g., well plates, culture plates, etc.) on the plate dock platform 30. For example, as illustrated in FIGS. 3A and 3B, the dock bar 32 and plate dock platform 30 can define mounting locations 34A-34C for six cartridges 2 to be placed thereon. Each mounting location 34A-34C can have an area configured to position a cartridge 2 of a predetermined (e.g., standard) size. In embodiments, each mounting location 34A-34C can be configured to tightly secure a corresponding cartridge 2. Having two possible orientations of the dock bar 32 enables the dock bar 32 to assist with positioning cartridges 2 for rocking laterally or longitudinally. Similarly, providing multiple possible locations for securing the dock bar 32 can enable cartridges 2 of different sizes to be positioned and secured on the plate dock platform 30.

Embodiments of the plate dock platform 30 can be configured to selectively support a stacking tray (e.g., a rack). In particular, the plate dock platform 30 can include stacking features that enable at least one additional plate dock platform 30 to be secured thereto, thereby forming multiple tiers of mounting locations. In embodiments, the stacking features include mounting structures, each of which is configured to secure an elevation structure thereto, which supports another tier of the stacking tray. In embodiments, one or more additional tiers of mounting locations can be selectively added or removed by a user without requiring removal of the platform 30 from the base 12, without any tools, and/or the like.

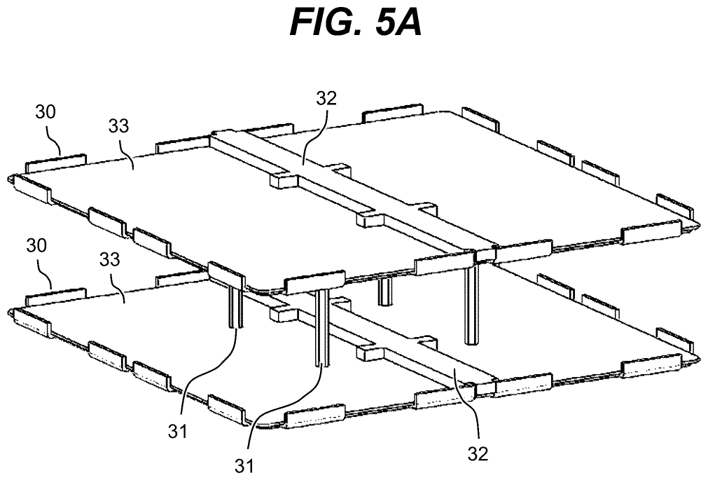

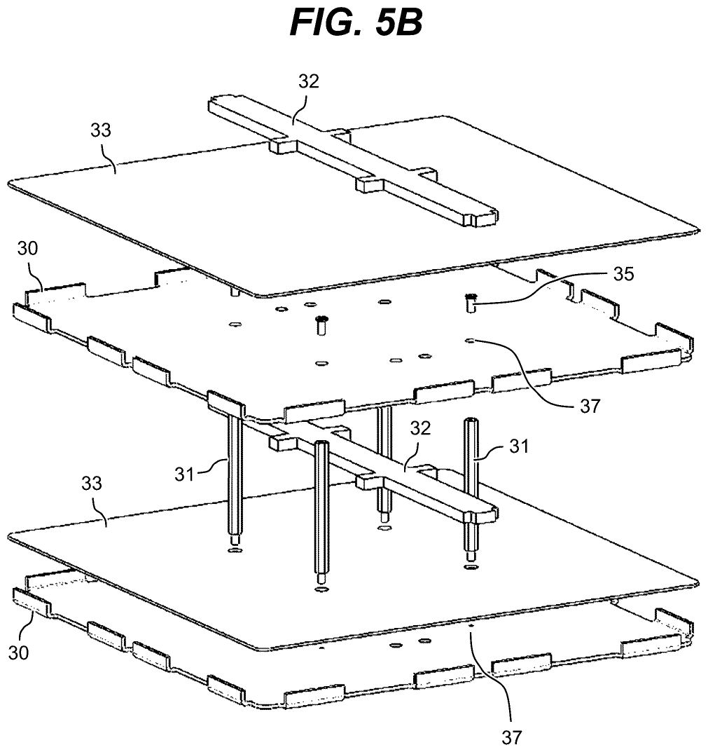

To this extent, FIGS. 5A and 5B show perspective and exploded perspective views of an illustrative multi-tier platform according to embodiments. Referring to FIGS. 4A-5B, the mounting structures of each plate dock platform 30 can include holes 37 (four illustrated) which can be used to fasten elevation structures, such as standoffs 31, for fabricating a stacking tray. For example, each standoff 31 can be configured to be partially inserted into the opening with a transition fit, include a threaded end that can be secured with a nut 35 inserted into the opening or located on an opposing side of the opening, and/or the like. In embodiments, the holes 37 are spaced to be located between the mounting locations 34A-34C formed by either orientation of the dock bar 32, thereby not inhibiting the placement of cartridges 2 thereon.

As illustrated in FIG. 5B, embodiments can include a traction surface 33, which is separate from the platforms 30 and configured for placement therein. The traction surface 33 can comprise a material configured to provide additional traction to prevent cartridges 2 and/or the like placed thereon from sliding on the platform 30 as it tilts. In embodiments, the traction surface 33 comprises a rubber mat, such as a textured neoprene rubber mat, a sticky surface silicone rubber mat, and/or the like. To accommodate the standoffs 31, the mounting surface 33 can include openings that are configured to be aligned with the holes 37 of the corresponding platform 30.

A stacking tray can provide one or more additional platforms 30 mounted above the plate dock platform 30 to provide additional platform area for the rocking device 10. In an embodiment, a stacking tray can approximately double the total platform area available for use. In further embodiments, a stacking tray can include two or more platforms 30 and/or be configured to selectively add any number of platforms 30 for positioning cartridges 2. In embodiments, each platform 30 can be individually selectively configured to position cartridges for rocking laterally and/or longitudinally. To this extent, an embodiment of the platform 30 and stacking tray can enable concurrent lateral and longitudinal rocking of multiple cartridges 2 located thereon.

It is understood that use of one or more reconfigurable platforms 30 is only illustrative of various approaches that can be utilized in order to place cartridges 2 in a desired orientation for rocking by the rocking device 10.

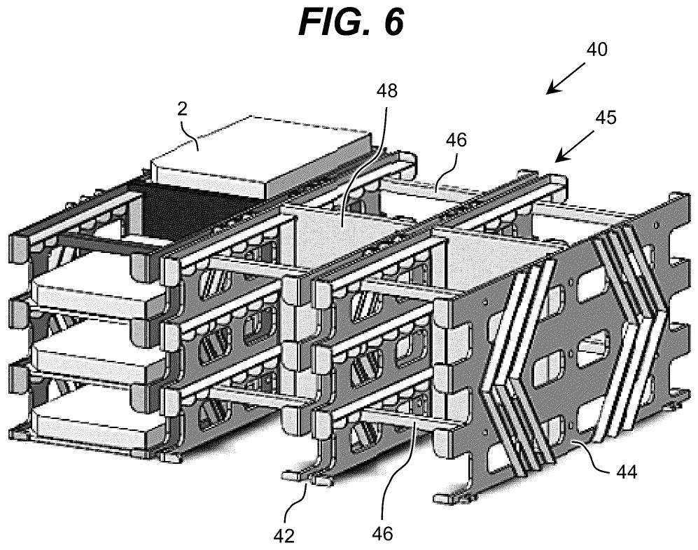

FIG. 6 shows an illustrative culture plate rack 40 according to embodiments. The rack 40 can be configured to secure multiple cartridges 2, such as well plate size cartridges, in a vertical and horizontal alignment. To this extent, the culture plate rack 40 is configured to hold multiple cartridges (e.g., six) on each of multiple tiers (e.g., four). In particular, the rack 40 is configured to hold up to twenty-four cartridges 2 in two three-by-four sides, but it is understood that this configuration is only illustrative of various possible embodiments of racks 40 that can be configured to hold any number of cartridges 2 of any of various sizes in any of various vertical and horizontal arrangements.

The rack 40 can include mounting slots 42, which enable the rack 40 to be mounted to a base plate platform, which is configured to be secured to the arms 26A, 26B (FIG. 2) of the rocking device 10 (FIG. 2). For example, the base plate platform 30 shown in FIG. 4A can include openings (similar to the openings 37) that align with the mounting slots 42 to enable the rack 40 to be secured thereto using, for example, screws. However, it is understood that this configuration is only illustrative and any of various approaches for securing the rack 40 to a base plate platform can be used. For example, in other embodiments, the slots 42 can form a dovetail shaped opening, which can be secured to a male dovetail located on the base plate platform (or removed therefrom), without requiring any tools or removal of the platform 30 from the base 12. In embodiments, the rack 40 can have a size that enables it to be securely placed on the platform 30, e.g., with the outer vertical projections of the platform 30 selectively securing the rack 40 in place, without requiring any tools or removal of the platform 30 from the base 12. In embodiments, the securing features are configured to enable the rack 40 to be selectively secured in either a lateral or longitudinal orientation.

In embodiments, the rack 40 can be fabricated from one or more injection molded parts. For example, the rack 40 can include side plates 44, each of which can be fabricated using injection molding. The side plates 44 can be secured to one another using any solution. For example, two side plates 44 can have complementary mounting structures located on one side which can enable one side plate 44 to be secured to another side plate 44 to form a centrally located vertical mounting structure 45 of the rack 40. The opposing side of each side plate 44 can include structures, such as ledges, which define and form the various mounting locations for the cartridges 2. Side plates 44 located on opposing sides of vertical columns of mounting locations for the cartridges 2 can be secured to each other using any solution. For example, the side plates 44 can be secured using bars 46 and/or plates 48, which can be formed using any solution. The bars 46 and/or plates 48 can be configured to provide an appropriate spacing between the two side plates 44 for the mounting locations for the cartridges formed therebetween. In this configuration, the side plates 44 and vertical plates 48 comprise elevation structures for the rack 40.

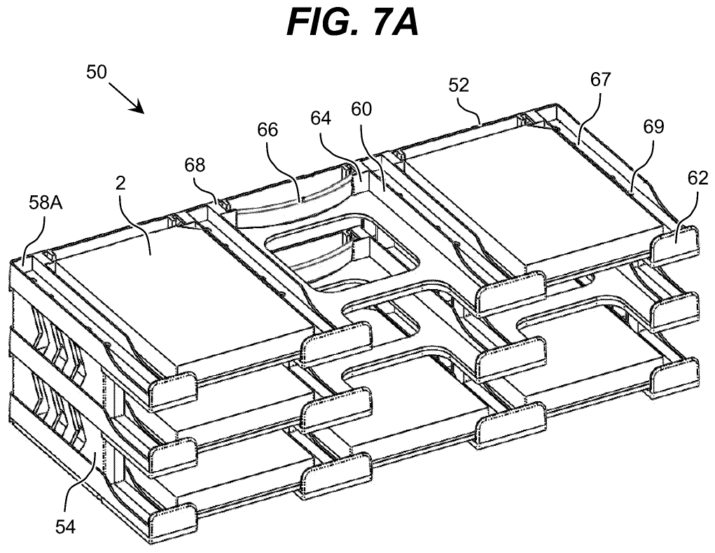

FIGS. 7A and 7B show perspective and exploded perspective views, respectively, of an illustrative cartridge rack 50 according to embodiments. As illustrated, the cartridge rack 50 is configured to hold up to nine cartridges 2. As shown most clearly in FIG. 7A, embodiments of the cartridge rack 50 can comprise an assembly composed of one or more rack level plates 52, with each additional rack level plate 52 separated from a rack level plate 52 located below by a plurality of spacer plates 54. The cartridge rack 50 can further include a rack mounting platform 56, which can be configured to secure the cartridge rack 50 to the arms 26A, 26B (FIG. 2) of the rocking device 10 (FIG. 2).

The rack level plates 52 and/or spacer plates 54 can be fabricated, for example, using injection molding. In the illustrated embodiment, four spacer plates 54 correspond to elevation structures, which separate each pair of rack level plates 52. Each rack level plate 52 has slots 58A, 58B, which provide mounting structures for the bottom and top of a corresponding spacer plate 54. As shown, each rack level plate 52 can have three cartridge bays. In embodiments, bolts, not shown, can pass vertically through the entire assembly and into the rack mounting platform 56 located below and shown in FIG. 7B to secure the components of the cartridge rack 50. In embodiments, a tier, including a rack level plate 52 supported by spacer plates 54, can be selectively added, removed, and/or reconfigured (e.g., reoriented) by a user without removing the rack mounting platform 56 from a rocking device 10, without requiring any tools, and/or the like.

In embodiments, each rack level plate 52 can have multiple mounting locations for cartridges 2. Each mounting location can be defined by side walls 60, toe walls 62, and a head wall 64 for positioning and securing the corresponding cartridge 2. The walls 60, 62, 64 also can add stiffness to the rack level plate 52. Furthermore, the side walls 60 also can be configured to position the spacer plates 54 using any solution, such as via a transition fit.

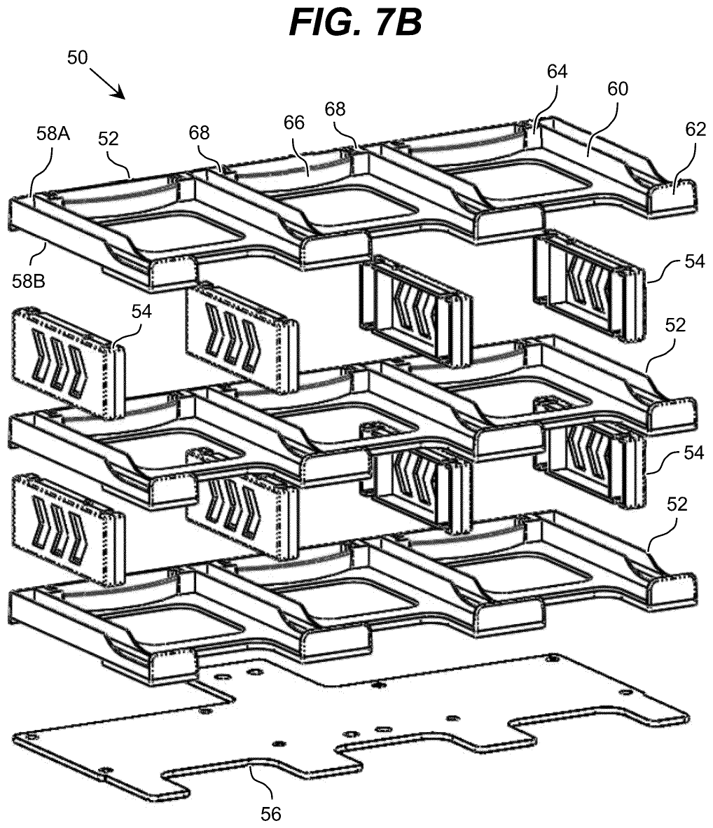

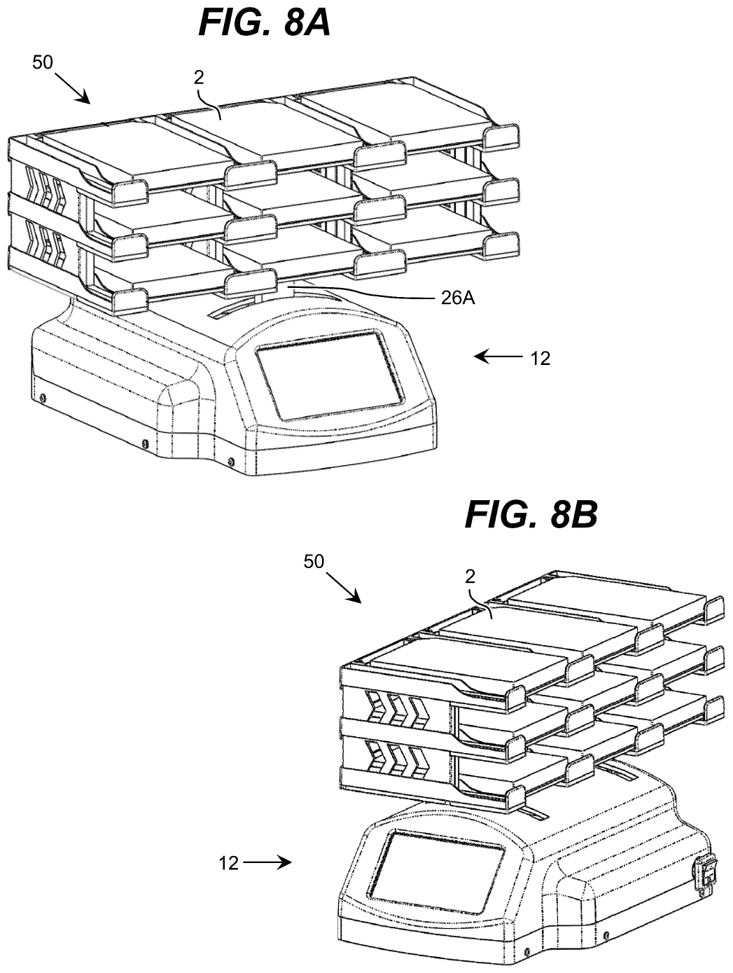

The cartridge rack 50 can be mounted to the base 12 (FIG. 2) of a platform rocker device 10 (FIG. 2) described herein in order to facilitate lateral or longitudinal rocking for the cartridges 2 mounted thereon. For example, FIGS. 8A and 8B show an illustrative cartridge rack 50 mounted to the base 12 of a platform rocker device 10 in two different orientations according to embodiments. In embodiments, the cartridge rack 50 can comprise or be mounted to a rack mounting platform 56 (FIG. 7B), which is attached to the arms 26A, 26B (FIG. 2) of the device 10, either facing forward (or backward), as illustrated in FIG. 8A or facing to a side (right or left), as illustrated in FIG. 8B.

In the configuration shown in FIG. 8A, the cartridges 2 can be inserted and removed from the cartridge rack 50 from the front side of the platform rocker device 10 and can be laterally tilted during operation of the platform rocker device 10. In the configuration shown in FIG. 8B, the cartridges 2 can be inserted and removed from the right side of the platform rocker device 10 and can be longitudinally tilted during operation of the platform rocker device 10. In embodiments, the cartridge rack 50 can comprise an integrated bottom surface providing the rack mounting platform 56 that is configured to be directly attached to the arms 26A, 26B.

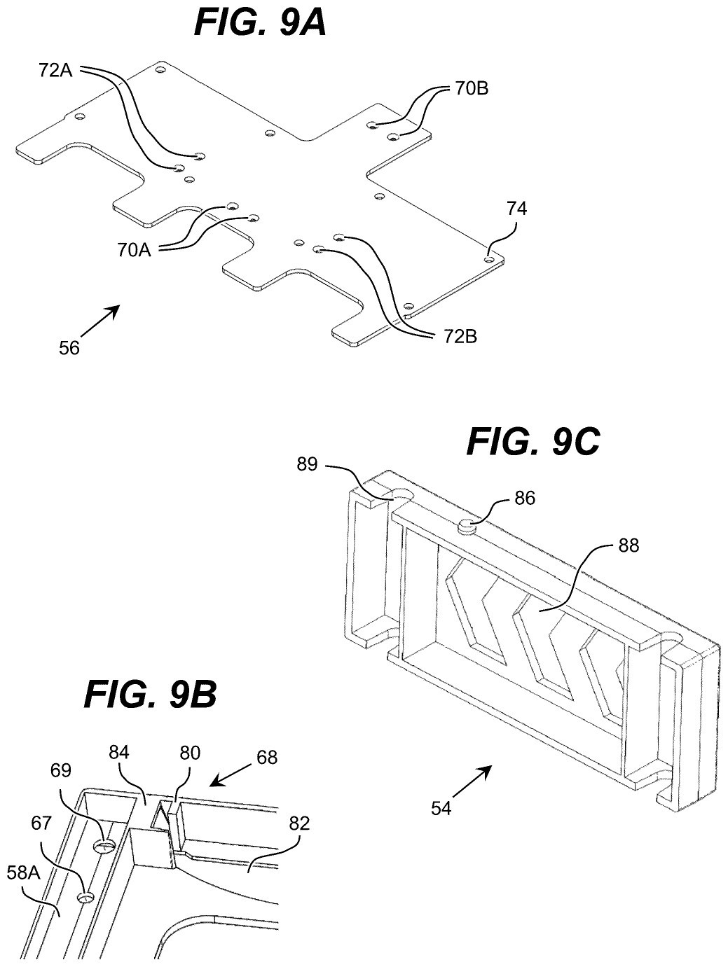

Further details of an illustrative cartridge rack 50 are shown and described with reference to FIGS. 9A-9C, which show more detailed views of illustrative components of an illustrative cartridge rack 50 according to embodiments.

FIG. 9A shows an illustrative rack mounting platform 56 according to an embodiment. To mount a cartridge rack, such as the cartridge rack 50, facing forward as shown in FIG. 8A, the front mounting holes 70A and rear mounting holes 70B can be used to mount the rack mounting platform 56 to the front and rear arms 26A, 26B, respectively, e.g., using the mounting holes 28 for the front and rear arms 26A, 26B as shown in FIG. 2. For example, as described herein, screws, such as flat head screws, can be threaded into the respective holes to mount the rack mounting platform 56 to the arms 26A, 26B. Alternatively, to mount the rack mounting platform 56 so that the cartridge rack 50 faces to the right, e.g., as shown in FIG. 8B, the front mounting holes 72A and rear mounting holes 72B can be used to mount the rack mounting platform 56 to the front and rear arms 26A, 26B, respectively.

The rack mounting platform 56 also can include various rack mounting holes 74 which can be used to mount the remainder of the cartridge rack 50 to the rack mounting platform 52. In embodiments, each of the rack mounting holes 74 can comprise a press nut or the like, which can make mounting a bottommost rack level plate 52 of the cartridge rack 50 to the rack mounting platform 52 easier. In embodiments, the rack mounting platform 56, can be fabricated to be fairly stiff and can provide stiffness to the cartridge rack 50. For example, in embodiments, the rack mounting platform 56 can comprise a plate fabricated from steel or the like.

Embodiments of a cartridge rack 50 can include mounting locations for the cartridges 2 that facilitate securing the cartridge 2 in place during operation of the platform rocker device 10 and facilitate ready removal of the cartridge 2 therefrom when a process is complete. As illustrated in FIGS. 7A and 7B, each mounting location for a cartridge 2 can include a flexible strip 66 that applies a light spring load on a cartridge 2 located therein. The spring load provided by the flexible strip 66 can prevent the cartridge 2 from sloshing around as the cartridge rack 50 is rocked and tilted during operation of the device 10. The flexible strip 66 can be fabricated using any solution. In embodiments, the flexible strip 66 comprises a flexible urethane belt.

In embodiments, the ends of the flexible strip 66 are captured in end pockets 68. Each end pocket 68 can be configured to assist in retaining the flexible strip 66 in place. To this extent, FIG. 9B shows a detail view of an illustrative end pocket 68 of a mounting location for a cartridge 2 according to embodiments. As illustrated, the end pocket 68 can include a tooth 80, which can assist in retaining an end of the flexible strip 66, which is not shown in FIG. 9B. The cartridge rack 50 can include a recess 82 in which the flexible strip 66 can travel. The recess 82 also can assist in retaining the flexible strip 66. Embodiments of the end pocket 68 also can include a top wall 84, which can trap the end of the flexible band 66 after its insertion below the top wall 84.

When inserting a cartridge into a corresponding mounting location, a user can push the cartridge 2 so that the flexible strip 66 compresses. The cartridge 2 can be pushed until it is retained in the mounting location by the toe walls 62. To remove the cartridge 2, the user can push the cartridge 2 to compress the flexible strip 66 and lift a front of the cartridge 2 over the toe walls 62.

FIG. 9C shows an illustrative spacer plate 54 according to an embodiment. In embodiments, for ease of assembly, each rack level plate 52 can have holes 67 (FIG. 7A, also shown in FIG. 9B) located within the slots 58A (FIGS. 7A and 7B, also shown in FIG. 9B), which are configured to mate with a transition fit with positioning bumps 86 shown on the spacer plate 54. Embodiments of the spacer plates 54 can include air holes 88, which can enable air to flow through the spacer plates 54, e.g., to allow for more air circulation around the cartridges.

Embodiments of the spacer plates 54 can include mounting slots 89 which are configured to align with mounting holes 69 (FIG. 7A, also shown in FIG. 9B) located within the slots 58A in the rack level plates 52. In embodiments, long bolts can pass through the mounting holes 69 and the mounting slots 89 into the rack mounting holes 74 (FIG. 9A). The bolts can be secured, for example, by threading into a press nut, or the like, at each rack mounting hole 74, into a separate nut secured underneath the rack mounting platform 56, and/or the like. The illustrated configuration allows for various numbers of tiers. In addition, in embodiments, each tier can have more or less than three cartridge bays with a simple tweak to the design of the rack level plate 52.

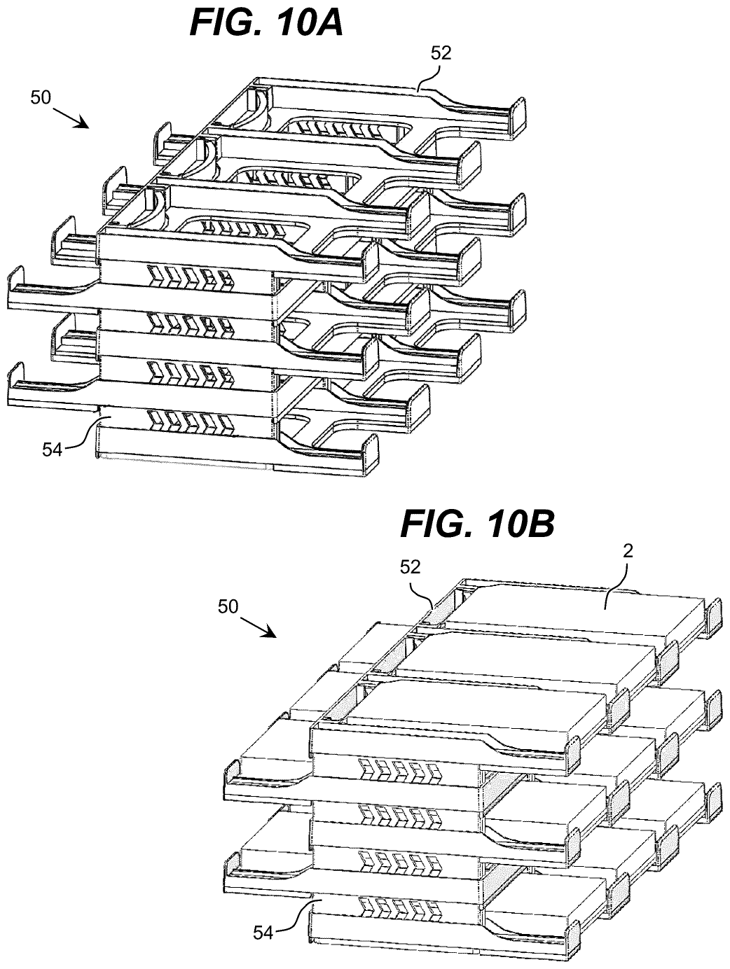

As illustrated in FIGS. 7A and 7B, the rack level plates 52 can be stacked such that all rack level plates 52 are facing the same direction. However, it is understood that this configuration is only illustrative. For example, FIGS. 10A and 10B show an illustrative cartridge rack 50, without and with cartridges 2, respectively, having an interdigitated arrangement according to embodiments. In this case, the spacer plates 54, slots 58A, 58B, holes 67, and bumps 86 shown in FIGS. 9B and 9C can be configured to enable the selective mounting of a rack level plate 52 facing either direction thereto. As illustrated, the rack level plates 52 are vertically spaced facing in alternating directions. Such a configuration can enable closer vertical spacing between the rack level plates 52. To this extent, embodiments of the spacer plates 56 can be shorter than the spacer plates shown in FIGS. 7A and 7B, which can result in the rack level plates 52 being vertically spaced closer together. However, it is understood that the same spacer plates can be used in both cartridge rack configurations.

FIG. 10B illustrates the interdigitated cartridge rack 50 with cartridges 2 mounted therein. This embodiment enables the interdigitated cartridge rack 50 to hold more cartridges in a given height than the cartridge rack configuration shown in FIGS. 7A and 7B, while allowing as much or more room above and below each cartridge 2. Such spacing can enable a person's hand to readily load and unload the cartridges 2. Alternatively, if the rack level plates 52 were spaced as close together facing the same direction instead of alternating directions, cartridges 2 in adjacent levels may interfere with a person's hand loading and unloading a cartridge 2 in the desired level.

It is understood that while the platforms described herein have been shown and described in conjunction with a rocker capable of performing additional motions, it is understood that the platforms can be utilized in conjunction with a currently available platform rocker.

As used herein, unless otherwise noted, the term “set” means one or more (i.e., at least one) and the phrase “any solution” means any now known or later developed solution. The singular forms “a,” “an,” and “the” include the plural forms as well, unless the context clearly indicates otherwise. Additionally, the terms “comprises,” “includes,” “has,” and related forms of each, when used in this specification, specify the presence of stated features, but do not preclude the presence or addition of one or more other features and/or groups thereof.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A device comprising:
a base;
a tiltable platform mounted to the base, wherein the tiltable platform includes a structure defining at least one side of each of a plurality of mounting locations located on the tiltable platform, each mounting location defining a position for placing a cartridge in a predetermined orientation with respect to movement of the tiltable platform, wherein the structure is configured for selective placement by a user in any one of a plurality of positions while the tiltable platform is mounted to the base, wherein the plurality of positions form mounting locations having differing sizes and/or differing orientations with respect to the base; and
a control unit configured to move the tiltable platform in a specified pattern as part of a process.

2. The device of claim 1, wherein the structure comprises a dock bar defining at least one side of each of the plurality of mounting locations, wherein the dock bar is configured to be secured to the tiltable platform in any of a plurality of dock bar locations.

3. The device of claim 2, wherein the plurality of dock bar locations includes a first dock bar location in which the mounting locations are laterally oriented with respect to the movement and a second dock bar location in which the mounting locations are longitudinally oriented with respect to the movement.

4. The device of claim 1, further comprising a second tiltable platform supported above the tiltable platform, wherein the second tiltable platform includes a second plurality of mounting locations located thereon.

5. The device of claim 4, wherein the tiltable platform and the second tiltable platform are configured to enable selective orientation of the plurality of mounting locations on the tiltable platform and the second plurality of mounting locations on the second tiltable platform in one of a plurality of possible orientations.

6. The device of claim 1, wherein each mounting location is configured to securely hold the cartridge in the predetermined orientation.

7. The device of claim 6, wherein the structure includes, for each mounting location, at least one toe wall and a flexible strip configured to press a cartridge against the at least one toe wall.

8. The device of claim 1, wherein the structure comprises a rack, wherein the rack defines a plurality of mounting locations for cartridges in each of a plurality of tiers.

9. The device of claim 8, wherein the rack includes:
a plurality of rack level plates, each rack level plate including a plurality of mounting locations for cartridges located on one of the plurality of tiers; and
a plurality of spacer plates, each spacer plate configured to secure two adjacent rack level plates with a predetermined spacing.

10. The device of claim 9, wherein the rack level plates and spacer plates are configured to enable selective mounting of a second rack level plate to a first rack level plate having one of a same or an opposite orientation.

11. A reconfigurable platform configured for mounting on a tiltable platform device, the platform comprising:
a platform configured to be secured to the tiltable platform device;
a first plurality of mounting locations located on a first tier on the platform, each mounting location configured to securely hold a cartridge in a first predetermined orientation with respect to movement of the platform by the tiltable platform device; and
a plurality of stacking features configured to define a second tier including a second plurality of mounting locations on the platform having a second predetermined orientation with respect to the movement of the platform, wherein the first predetermined orientation and the second predetermined orientation are selected from a plurality of user selectable predetermined orientations with respect to the movement of the platform.

12. The platform of claim 11, wherein at least one side of each of the first plurality of mounting locations is defined by a dock bar, wherein the dock bar is configured to be secured to the platform in any of a plurality of locations.

13. The platform of claim 11, wherein the plurality of stacking features include a plurality of elevation structures configured to be secured to the platform, wherein the plurality of elevation structures are configured to support and/or define the second tier including the second plurality of mounting locations located above the first plurality of mounting locations located on the first tier on the platform.

14. The platform of claim 11, wherein each of the first plurality of mounting locations and the second plurality of mounting locations are formed by first and second rack level plates.

15. The platform of claim 14, wherein the first rack level plate includes a plurality of slots, each slot configured to secure a spacer plate for supporting the second rack level plate above the first rack level plate.

16. The platform of claim 14, wherein each mounting location includes at least one toe wall and a flexible strip configured to press a cartridge located in the mounting location against the at least one toe wall.

17. A multi-tier platform configured for mounting on a tiltable platform device, the platform comprising:
a plurality of tiers, each tier including a plurality of mounting locations, each mounting location configured to securely hold a cartridge in a predetermined orientation with respect to movement of the platform, wherein the predetermined orientation is selected from a plurality of user selectable predetermined orientations with respect to the movement of the platform; and
a plurality of elevation structures defining a predetermined spacing between the plurality of tiers.

18. The platform of claim 17, wherein the plurality of elevation structures enable the plurality of mounting locations on a first tier and a plurality of mounting locations on a second tier to be selectively aligned in one of a plurality of possible alignments.

19. The platform of claim 17, wherein each mounting location includes at least one toe wall and a flexible strip configured to press a cartridge located in the mounting location against the at least one toe wall.

20. The platform of claim 17, wherein at least one side of each of the plurality of mounting locations of each tier is defined by a dock bar, wherein the dock bar is configured to be secured to a platform for the tier in any of a plurality of dock bar locations.
